(19) United States
(12) Patent Application Publication
(10) Pub. No.: US 2024/0083178 A1
(43) Pub. Date: Mar. 14, 2024

(54) DIRECT PRINTING MACHINE

(71) Applicant: Krones AG, Neutraubling (DE)

(72) Inventor: Stefan Richter, Thalmassing (DE)

(21) Appl. No.: 18/463,881

(22) Filed: Sep. 8, 2023

(30) Foreign Application Priority Data
Sep. 9, 2022 (DE) 102022122911.4

(51) Int. Cl. B41J 3/407; B41J 2/165

(52) U.S. Cl. CPC B41J 3/40733; B41J 2/16517

(57) ABSTRACT

The disclosure relates to a method for printing on containers, wherein the containers rotate in a transport carousel, and a co-rotating printing station is assigned to each container on the transport carousel, and the containers are finally printed by the respective printing station having a single print head having a maximum of two ink supplies only in a partial region of the printable container height. The disclosure further relates to a direct printing machine for carrying out the aforementioned method.

### CROSS REFERENCE TO RELATED APPLICATION

The present application claims priority to German Patent Application No. 10 2022 122 911.4 filed on Sep. 9, 2022. The entire contents of the above-listed application are hereby incorporated by reference for all purposes.

### TECHNICAL FIELD

The present disclosure relates to a method for printing on containers and to a direct printing machine.

### BACKGROUND

In filling plants for beverages, but also in the pharmaceutical industry, containers, e.g., plastic containers—in particular, bottles made of polyethylene terephthalate (PET), and those made of glass or pulp—are equipped for marking by means of labels or else printed on by means of color/inks.

### SUMMARY

For printing, direct printing machines are used, for example, in which the containers are placed on a turntable of a container carousel on which they are then also rotated and printed on during circulation. There are systems in which the printing devices are arranged in a stationary manner outside the transport carousel and those in which the printing stations rotate along with the transport carousel.

Direct printing machines preferably provide the containers to be processed with graphic elements, text, and codes, such as 2-D codes.

If the printing device is located outside the transport carousel, a printing device is not required for each turntable, but the rotational speed of the rotary carousel is limited by the process of external printing. This type of printing therefore results in low process speeds—particularly in the case of more complex container labels.

If the printing devices are attached in a co-rotating manner within the transport carousel, only the rotational speed of the turntables, but not that of the carousel, must be adapted to the printing process. In addition, it is possible to print simultaneously on all turntables that carry a container. The nominal output of the direct printing machine can thus be increased compared to printing by means of a printing device arranged externally.

In order to print different markings on a wide variety of containers, the individual printing devices of the direct printing machines typically have several print heads having different inks, which usually print on the containers in multiple colors over the entire area/height that can be printed on the container. The associated printing times thus increase, resulting in high printing ink consumption.

Proceeding from this, the object of the present disclosure is to provide alternatives to this, and to propose a method and a device that make it possible to increase the nominal output and thus the throughput performance of direct printing machines, and/or at the same time to reduce the process and machine costs.

According to the disclosure, this object is achieved by a method and a device as described herein.

The disclosure thus proposes limiting the printing to a maximum of two colors that are applied to the containers with a single color print head, and also only to a partial region of the available printable overall height of a container. As a result of this “less,” the effort to implement the co-rotating printing stations is reduced. At the same time, the entire printing process is also shortened, because only a maximum of two colors, and preferably even only one, are printed for the final print. In addition, printing ink is saved, so that the method according to the disclosure and the device can still conserve resources while simultaneously increasing performance, and therefore are also advantageous from an environmental point of view. In typical containers such as bottles, the theoretically maximum printable region extends from the bottom to the region of the shoulder where the bottle transitions into the neck. For typical bottle heights of 15 to 35 cm, the typically printable region is only 3 to 4/5 thereof. According to the disclosure, only a partial region, i.e., for example, only 3 to 14 cm, of this region is printed on. In this way, for example, it would be possible, in a targeted manner, to print only the usual brand lettering of a soft drink bottle in relief.

Preferably, the partial region that is printed on can be adjusted by changing the height and/or the inclination angle of the print head. The printing process can thus be adapted to the different container shapes.

In particular, the print head can also be adjusted in the direction of the container thickness, i.e., in the direction of the axis of the turntable, in order to be able to adapt the print head to containers of different diameters.

Preferably, a partial region of the printable container height is printed on, which makes up a maximum of half, and in particular only a third, of the printable container height. Furthermore, because only one print head is present in each printing station, the machine is lighter than conventional machines equipped with several print heads per station, allowing for energy-efficient operation.

Preferably, the container is oriented in the preferred rotary position before printing. Particularly preferably, features such as embossing, debossing reliefs, and support elements are detected by means of optical sensors or cameras, which are subsequently oriented in such a way that these structures can be printed on in a targeted manner—completely or partially. Partially printed can mean that glass lettering is printed on with a contrast color only on its outer contour, or that only the peaks of a mountain panorama are printed with a white contrast color. In an advantageous embodiment of the disclosure, it is possible to use an optical detection unit to determine whether the print to be applied is already present on individual containers to be processed—for example, a burn-in finish. In these treatment stations, further printing can be selectively suppressed or, in the case of missing partial regions, post-printing of missing parts or fragments be selectively performed.

Preferably, the ink for printing the containers is supplied from at least one tank co-rotating with the transport carousel. As a result, a rotary feed-through in the ink supply system can be dispensed with, because the at least one ink tank rotates with the carousel and can thus be connected to the print head via simple lines.

Preferably, a labeling assembly for labeling the containers is also arranged at the periphery of the transport carousel. Thus, the containers can also be labeled—in particular, as an alternative to printing. As a result, the variability of the machine with respect to different labeling methods can be increased.

The labeling assembly can in particular also be operated simultaneously with the direct printing machine. For example, a price label can be labeled and a graphic element can be printed at the same time.

Furthermore, a pre-treatment unit for pre-treating the containers can also be arranged at the periphery of the transport carousel. The pre-treatment allows the print quality to be improved and promotes smooth direct printing.

In a further embodiment of the disclosure, each printing station is assigned a co-rotating post-treatment unit that post-treats the containers—in particular, by using light, and in particular UV light emitted by pinning lamps. Post-treatment fixes the ink applied to the container during direct printing, making the marking more durable. By assigning a post-treatment unit to each printing station, the throughput speed is further increased, because the containers can be post-treated immediately after printing until they leave the transport carousel. In the case of external, non-co-rotating post-treatment units, the post-treatment would be limited to a specific process region resulting from the containers passing the stationary post-treatment unit.

Preferably, a cleaning device is also arranged at the periphery of the transport device, which cleaning device cleans the printing stations and/or the turntable—in particular, after the printed and post-treated container has been removed from the transport carousel and before a container is received in the transport carousel again. Thus, the smooth operation of the direct printing is ensured even in the case of long maintenance intervals, because the printing stations and the turntable are less contaminated by ink or other substances.

Preferably, the machine is also equipped with a final optical inspection system, which subsequently ejects containers found to be defective from the container flow by means of an ejection unit. The final inspection system preferably includes a closed-loop function, by means of which the applied print is evaluated qualitatively, and correction data or raw data can be provided for alignment and print control. The correction data or raw data can contain information about the rotational position, size, coordinates, and degree of coverage of the print.

The advantages of the features according to the disclosure described above also apply to claim 8 and to the features of the direct printing machine that are claimed in the dependent device claims.

### BRIEF DESCRIPTION OF THE FIGURES

The disclosure is explained in more detail below with reference to the figures.

FIG. 1 is a schematic plan view of a direct printing machine according to the disclosure;

FIG. 2 is a schematic side view of a printing station according to the disclosure during printing of a cylindrical container;

FIG. 3 is a schematic side view of a printing station according to the disclosure during printing of a conical container.

### DETAILED DESCRIPTION

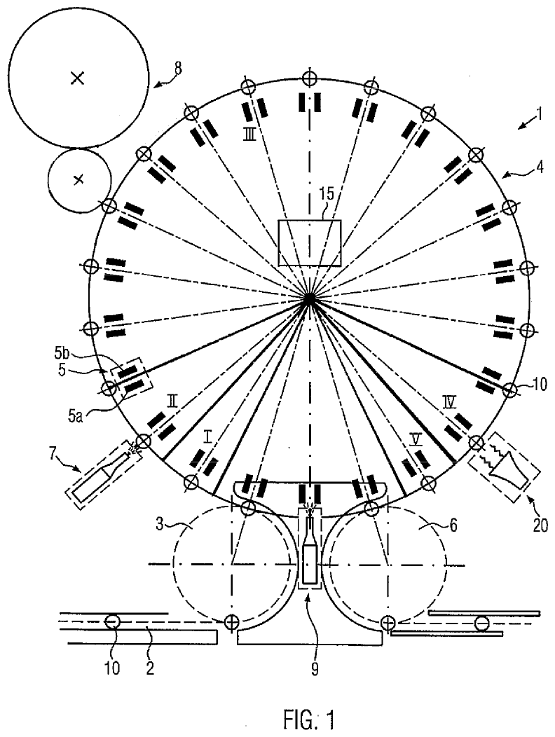

FIG. 1 shows a direct printing machine 1 having a transport carousel 4 having a plurality of printing stations 5 formed thereon, on which containers 10 standing on turntables (not shown) can be printed on during the circulation of the transport carousel.

The containers are transferred by a conveyor belt 2 via an intake star 3 to the individual printing stations of the transport carousel 4 and leave the carousel completely printed—i.e., no further printing takes place thereafter—via an outlet star 6. They can then be transported directly or via a further transport path—for example, to a filler.

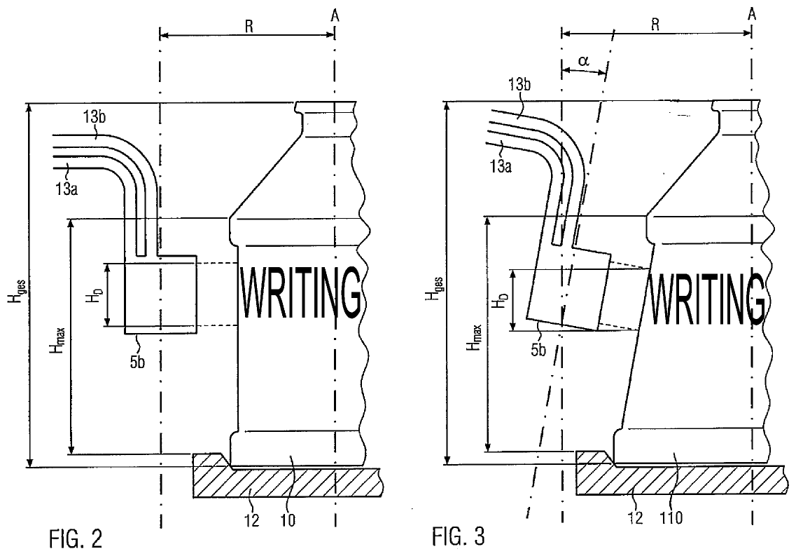

A single print head 5b, and optionally a pinning lamp 5a, are arranged at each printing station 5 for printing on a partial region HD of the container with only one color, e.g., black or white, and for subsequent post-treatment. In the partial region HD, it is possible to print on the container 10 around the entire circumference or even only a part of the circumference. As shown in FIGS. 2 and 3, the print head itself can optionally have two ink supply connections, so that it is possible to choose between two printing inks. The ink supply connections 13a and 13b are supplied by at least one ink tank 15, which is positioned—in particular, in a co-rotating manner—on the transport carousel 4. It is thus possible to print on the containers with a maximum of two different colors. In particular, however, only one ink supply with one color may be provided. When printing with only one color, preference is given to selecting a contrast color for the container color or, in the case of transparent containers 10, the color of the liquid. In this way, readability of the marking can be achieved with only one color.

In addition, as can also be seen from FIGS. 2 and 3, the print region of each print head can be adjusted both in height and in distance from the axis of rotation A of each turntable, as well as in the inclination angle to the container.

After a container has been transferred, it can be oriented for subsequent printing in a first region I—in particular, with the aid of sensors (not shown); in the second region II, a pre-treatment can then be carried out with the aid of a pre-treatment unit 7.

The actual printing process takes place via the subsequent third region III, which in this embodiment extends over 240°. The printed container can then be fully cured in the subsequent fourth region IV by means of a post-treatment unit 20—in particular, a UV-light-emitting—preferably LED or mercury vapor—lamp—which can be provided in addition to or as an alternative to the individual, co-rotating pinning lamps 5a.

Finally, the marking produced by printing can be checked in the fifth region V—in particular, with the aid of sensors (not shown).

Particularly between the two rotary stars 3 and 6, the unoccupied printing station 5 and the turntable (not shown) can now be freed of ink residues and other dirt by means of the cleaning unit 9.

Because the individual printing stations 5 are realized relatively simply and therefore take up less space, there is sufficient space to also arrange one or even more labeling assemblies 8 at the periphery of the carousel in such a way that the machine can also be used for labeling—optionally or in addition to printing. The labeling assembly is preferably an assembly by means of which round labels can be applied.

Furthermore, a cleaning unit 9 for cleaning the printing stations 5 can also be arranged at the periphery of the transport carousel 4.

With reference to FIG. 2, the disclosure is further explained below with reference to an example, in which a substantially cylindrical bottle is printed on.

FIG. 2 shows a commercially available bottle to be provided with a marking on the turntable 12 in a printing station 5. For example, the bottle has a total height H_{ges} between 15 and 35 cm. The maximum printable region Hₘₐₓ, which, in the case of standard bottles, extends from the bottom to the beginning of the tapering shoulder region/bottle neck, is therefore less than the total height, and is only approximately 3/5 to 4/5 thereof.

According to the disclosure, the single print head 5b of the printing station 5 prints on only a partial region HD thereof, which partial region preferably extends over less than half, and in particular less than just one third, of the Hₘₐₓ. In the exemplary embodiment shown, this is the region of the brand lettering, which is embossed into the bottle, for example, in a relief-like manner, as is customary, for example, in soft drink bottles.

For this purpose, the print region of the print head is adjustable in height to match the height of this region, either by the adjusting the height of the entire print head or by using only a part of the print nozzles of a print head that extends over a greater height. Preferably, the print heads are height-adjustable by means of a motor drive; particularly preferably, all print heads are height-adjusted by means of a common drive.

The distance R from the axis of rotation A of the turntable can also be adjusted.

FIG. 3 shows a container 110 for printing on a printing station 5, the shape of which container differs from that in FIG. 2 in that the maximum printable region Hₘₐₓ tapers conically from the bottom of the container to the neck. In order to be able to print on such containers, the inclination angle α of the print head 5a of the printing station 5 according to the disclosure can also be adjusted accordingly. Preferably, the inclination angle of the print heads can be adjusted by means of a motor drive.

1. Method for printing on containers, wherein the containers rotate in a transport carousel, and a co-rotating printing station is assigned to each container on the transport carousel,
wherein
the containers are finally printed by the respective printing station having a single print head having a maximum of two ink supplies only in a partial region of the printable container height.

2. Method according to claim 1, wherein the partial region can be adjusted by changing the height and/or inclination angle of the print head.

3. Method according to claim 1, wherein the printed on partial region constitutes a maximum of one third of the printable container height.

4. Method according to claim 1, wherein the at most two ink supplies for printing on the containers are supplied with ink by at least one tank co-rotating with the transport carousel.

5. Method according to claim 1, wherein the containers are labeled with a labeling assembly arranged at the periphery of the transport carousel.

6. Method according to claim 1, wherein the containers are pretreated with a pre-treatment device arranged at the periphery of the transport carousel.

7. Method according to claim 1, wherein a co-rotating post-treatment unit is assigned to each printing station, and the containers are post-treated by the post-treatment unit.

8. Direct printing machine for printing on containers, comprising a transport carousel for transporting containers standing on turntables, each having one co-rotating printing station per container,
wherein
each printing station has a single print head having at most two ink supplies, and the printing stations are configured in such a way that they print on only a partial region of the printable container height.

9. Machine according to claim 8, wherein the printing stations are configured in such a way that the position of the print heads in the direction of the container height and the inclination angle of the print heads can be changed.

10. Machine according to claim 9, wherein the printing stations are configured in such a way that they print on the containers at most in a partial region of one third of the printable container height.

11. Machine according to claim 10, wherein the at most two ink supplies of the printing stations are supplied with ink by at least one tank co-rotating with the transport carousel.

12. Machine according to claim 11, wherein a cleaning device for cleaning the print heads is arranged at the periphery of the transport carousel.

13. Machine according to claim 8, wherein a labeling assembly for labeling the containers is arranged at the periphery of the transport carousel.

14. Machine according to claim 8, wherein a pre-treatment device for pre-treating the containers is arranged at the periphery of the transport carousel.

15. Machine according to claim 8, wherein each printing station is assigned a co-rotating post-treatment unit for post-treating the containers.
